(19) United States
(12) Patent Application Publication
(10) Pub. No.: US 2006/0204029 A1
(43) Pub. Date: Sep. 14, 2006

(54) Speaker unit and sound output device

(76) Inventor: Teruo Mori, Tokyo (JP)

Correspondence Address: HOGAN & HARTSON L.L.P., 500 S. GRAND AVENUE, SUITE 1900, LOS ANGELES, CA, 90071-2611, US

(21) Appl. No.: 10/527,236

(22) PCT Filed: Jan. 8, 2004
(86) PCT No.: PCT/JP04/00066

§ 371 Date: May 2, 2006

(30) Foreign Application Priority Data
Jan. 9, 2003 (JP) 2003-003532

(51) Int. Cl. H04R 11/02

(52) U.S. Cl. 381/423

(57) ABSTRACT

In a speaker core (10) and a speaker unit using the same, a counter-mass (18), which utilizes the masses of a receiver circuit (31), a battery (32) and a case (33), is provided on one end side of a vibrator (12), and a vibration generated by using a drive coil (13) to drive the vibrator (12) to perform expanding/contracting movements is effectively transmitted to a diaphragm (20) positioned on the other end of the vibrator (12).

### TECHNICAL FIELD

The present invention relates to a speaker unit and a sound output device.

### BACKGROUND ART

Conventional speaker units which output sound (sound and voice) generally have vibrated a diaphragm by electromagnetic induction, or by driving a vibrator of piezoelectric ceramic or the like connected to the diaphragm.

Recently, giant magnetostrictive materials, known for their high response, have been attracting attention as vibrators used for these speaker units.

A speaker unit, which uses a giant magnetostrictive material, connects an elongate, rod-shaped vibrator of the magnetostrictive material at one end to a diaphragm, and drives the vibrator to expand/contract in the axial direction of the vibrator by a magnetic field generated to work in the axial direction by a magnetic field generating coil. Such a speaker unit is disclosed by, e.g., Japanese Patent Laid-Open No. 10-145892.

In a speaker unit with a vibrator of giant magnetostrictive material, which vibrates a diaphragm by driving the vibrator to expand/contract in the axial direction, vibration is generated in the vibrator not only at the end on the diaphragm side but also at the opposite end to the same extent, when a magnetic field is simply applied to the vibrator itself. As a result, only half of vibration generated by the vibrator is transmitted to the diaphragm, unless an adequate measure is not taken.

When a vibrator of giant magnetostrictive material is used, therefore, it is fixed at one end and free at the other end in contact with a diaphragm. In other words, it should be structured in such a way that the stationary end of the vibrator is certainly fixed to a stationary object of certain mass, e.g., speaker unit enclosure, to which it is pressed to be restricted, in order to allow vibration to be generated only at the free end without being dissipated in other portions of the vibrator. Such a structure needs a robust enclosure or the like as an essential component, which limits the down sizing and light weighting of speaker unit.

The present invention is developed to solve these technical problems. It is an object of the present invention to provide a speaker unit and sound output device, which can be made compact and light even when a vibrator of giant magnetostrictive material is used.

### DISCLOSURE OF THE INVENTION

The speaker unit of the present invention comprises a vibrator having one end and the other end and vibrating in a given direction in response to an external signal (electrical signal), counter-mass which is provided on the one end of the vibrator, and diaphragm connected to the vibrator at the other end and outputting sound when it receives vibration from the vibrator, wherein the counter-mass transmits vibration in a concentrated manner to the diaphragm side.

The counter-mass should have a given multiple or more of mass than that of the vibrator to transmit vibration from the vibrator in a concentrated manner. For example, it preferably has 10 to 200 times mass larger than that of the vibrator, more preferably 100 to 200 times larger. This enables the counter-mass to have a sufficient inertia force against a force causing vibrator displacement and results in transmitting the vibration from the vibrator to the diaphragm in a concentrated manner.

The counter-mass can be made of a soft magnetic material, e.g., Mn—Zn-based ferrite.

The diaphragm is in contact with the vibrator at the other end of the vibrator, not necessarily directly. The diaphragm may be in contact indirectly with a tip end side of the vibrator via a member, which transmits vibration of the vibrator to the diaphragm.

When the speaker unit is of the so-called wireless type, which is additionally provided with a receiver circuit for receiving an external signal transmitted wirelessly and a battery for supplying electric power to the receiver circuit, at least one of the receiver circuits and the battery may be used as the counter-mass.

The signal may be wirelessly transmitted by the so-called wireless communication, infrared communication, optical communication or the like. The wireless communications include a short-distance wireless connection, e.g., Bluetooth®.

As the vibrator, a piezoelectric element or the like may be employed. However, a giant magnetostrictive material is suitable therefor in consideration of its sound range properties and capacity of being made compact. In particular, magnetostrictive element of giant magnetostrictive materials includes Tb, Dy and Fe is preferable as the vibrator.

Moreover, a permanent magnet, which applies a bias magnetic field to the vibrator, is preferably provided on an axis of the vibrator.

The permanent magnet is preferably provided at both ends of the vibrator.

It is well known that a conventional speaker is a speaker unit with an integrated diaphragm.

However, a diaphragm may not be integrated in the speaker unit by use of the above-described vibrator vibrating in a given direction in response to a signal, because the speaker unit can constitute a sound output device, which outputs sound when it is pressed to an adequate object working as the diaphragm.

It is preferable that the sound output device comprises a counter-mass which is positioned on one end of a vibrator and has a given multiple or more of mass than that of the vibrator, housing which holds the vibrator and counter-mass, and transmission member which transmits vibration generated by the vibrator at the other end to the housing outside. It is also preferable that the counter-mass provides an inertia force only in the vibration direction of the vibrator. It is therefore preferable that the counter-mass is provided on the axial direction of the vibrator while spreading in the radial direction is prevented as far as possible.

The transmission member may be provided as a separate member, or the other end of the vibrator may be projected to the housing outside to work as the transmission member.

The sound output device may have a structure with a first permanent magnet positioned between the counter-mass and vibrator, and a second permanent magnet between the transmission member and vibrator.

By structuring the housing such that the length thereof in the vibrator direction of the vibrator is larger than that in the direction perpendicular to the vibration direction, the sound output device may be stick-shaped as a whole. This provides the sound output device of unprecedented outer appearances.

A magnetostrictive element of giant magnetostrictive material, e.g., that containing Tb, Dy and Fe, is preferable for the vibrator in consideration of its sound range properties and capacity of being made compact, as discussed earlier. When the above element is used as the vibrator, a drive coil is provided around the vibrator in the housing for generating a magnetic field in response to an incoming signal and making the vibrator vibrate with the magnetic field.

In the sound output device of the present invention, the counter-mass can provide an inertia force only in the vibration direction of the vibrator when the vibrator vibrates.

The counter-mass having a mass of 10 to 200 times larger, preferably 100 to 200 times larger, than that of the vibrator may be used accordingly.

For example, a receiver circuit for receiving an external signal transmitted wirelessly and a battery for supplying electric power to the receiver circuit are used as the counter-mass together with the casing in which they are held.

A sound output device with an integrated diaphragm is also within the scope of the present invention. Therefore, it may be additionally provided with a diaphragm to which vibration from the vibrator is transmitted via a transmission member to output sound.

In the above device, the housing and diaphragm are preferably attached to each other via a joint.

The sound output device of the present invention may be of the so-called stick-shaped one comprising a cylindrical housing, a receiver which is held in the housing for receiving an external signal transmitted wirelessly, and a vibrator which is held in the housing and vibrates in the axial direction of the housing in response to the signal received by the receiver, and transmission member which transmits vibration from the vibrator to the outside.

The above sound output device can be provided with a receiver circuit for receiving an external signal transmitted wirelessly, and a battery for supplying electric power to the receiver circuit, both built in a casing held in a housing, wherein the casing preferably has a given multiple or more of mass than that of the vibrator, together with the receiver circuit and the battery which it holds.

The vibrator may be of a piezoelectric element, supersonic element or the like. However, the vibrator is preferably a magnetostrictive element comprising a sintered body having an atomic composition of Tb_{X}Dy_{1-X}Fe_{Y} (wherein, X is 0.25 to 0.50 and Y is 1.7 to 2.0). When the magnetostrictive element is used as the vibrator, a drive coil is provided around the vibrator in the housing for generating a magnetic field in response to an incoming signal and making said vibrator vibrate with the magnetic field.

In the above sound output device, in which a magnetostrictive element is used as the vibrator, it is effective to provide a permanent magnet which applies a bias magnetic field to the magnetostrictive element. In this case, the permanent magnet is preferably provided on the vibration direction of the magnetostrictive element (on the magnetostrictive element axis). By providing the permanent magnet on the counter-mass side, it can work as a counter-mass.

The sound output device of the present invention may be stick-shaped as a whole by keeping length in the vibrator vibration direction larger than that in the direction perpendicular to the vibration direction.

By structuring the housing such that the length thereof in the vibrator direction of the vibrator is larger than that in the direction perpendicular to the vibration direction, the sound output device of the present invention may be stick-shaped as a whole.

The sound output device described above is suitably used as a portable one.

### BRIEF DESCRIPTION OF THE DRAWINGS

FIG. 1 illustrates a speaker core structure as one of the embodiments of the present invention;

FIG. 2 gives characteristics of a magnetostrictive element used as a vibrator;

FIG. 3 presents a graph showing the relationship between the expanding/contracting (vibration) displacement of a vibrator and current supplied to a drive coil;

FIG. 4 illustrates a structure with a battery or the like as a counter-mass for a speaker core; and

FIG. 5 illustrates a speaker unit structure with a diaphragm fixed on a speaker core.

### BEST MODE FOR CARRYING OUT THE INVENTION

The present invention is described in detail by referring to the attached drawings, which illustrates the embodiments of the present invention.

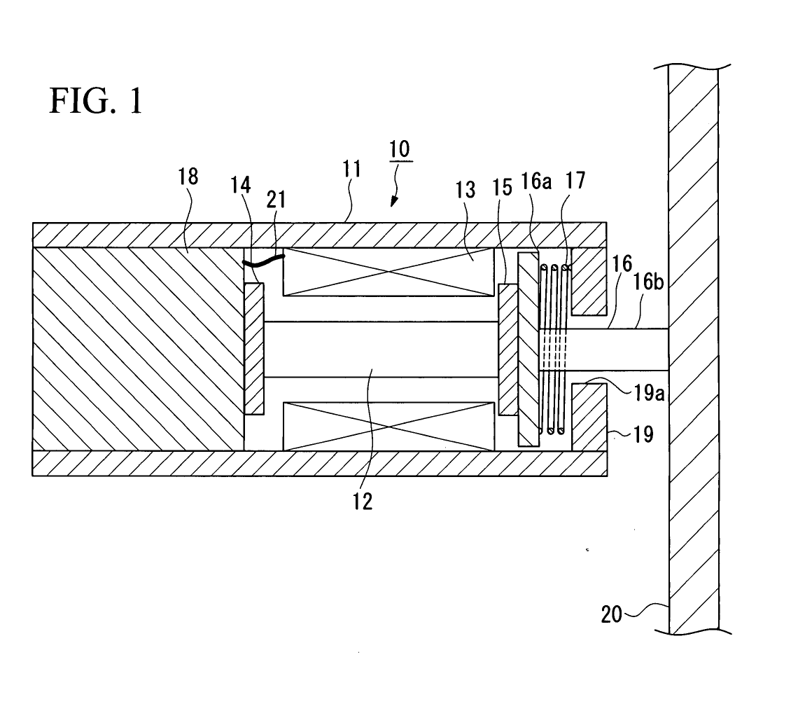

FIG. 1 illustrates a basic structure of the stick-shaped speaker core of this embodiment.

As illustrated in FIG. 1, a speaker core (sound output device) 10 comprises a cylindrical housing 11 which holds a vibrator 12, a drive coil 13 which drives the vibrator 12, a magnet (first permanent magnet) 14, a magnet (second permanent magnet) 15, transmission rod (transmission member) 16, preload member 17 and counter-mass 18.

The housing 11 is cylindrical having a cross-sectional shape of circle, polygon or the like. It has a length in the axial direction larger than that in the radial direction perpendicular to the axial direction, and is open at least at one end (both ends are open in the example illustrated in FIG. 1). It holds an elongate, rod-shaped vibrator 12 having a given length around the centerline of the housing 11. The housing 11 may be made of a resin based material, metal based material, ceramic or the like. It may have an outer diameter of 8 to 16 mm, inner diameter of 6 to 14 mm and length of 20 to 45 mm.

Around the outer circumference of the vibrator 12, the drive coil 13 fixed to the inner circumference of the housing 11 by an adequate fixing means is provided so as to face the vibrator 12 in a noncontact manner. The drive coil 13 can generate a magnetic field in the direction of the vibrator 12 axis (i.e., direction of the housing 11 centerline), when energized with electric power supplied from a power source (not shown).

The drive coil 13 and vibrator 12 are apart from each other, and the clearance may be set at 0.1 to 0.5 mm. The drive coil 13 may be produced by winding a conductor (diameter: 0.05 to 0.20 mm) to have a 50 to 400 turns and having length of 12 to 31 mm.

The vibrator 12 is driven by a magnetic field generated by the drive coil 13 to expand/contract in the direction of the housing 11 axis (given direction).

The vibrator 12 may be made of a giant magnetostrictive material, for example. A giant magnetostrictive material is a laves-type cubic system (RT₂) composed of a lanthanoid element R of high magnetic moment and iron group element T. Specifically, the suitable materials are sintered material having an atomic composition represented by Tb_{X}Dy_{1-X}Fe_{Y} (wherein, X is 0.25 to 0.50 and Y is 1.7 to 2.0). Some of other giant magnetostrictive materials having a high magnetostrictive value include SmFe_{Z} crystals (Z=1.7 to 2.0). The vibrator 12 may have a diameter of 1 to 6 mm and length of 3 to 30 mm.

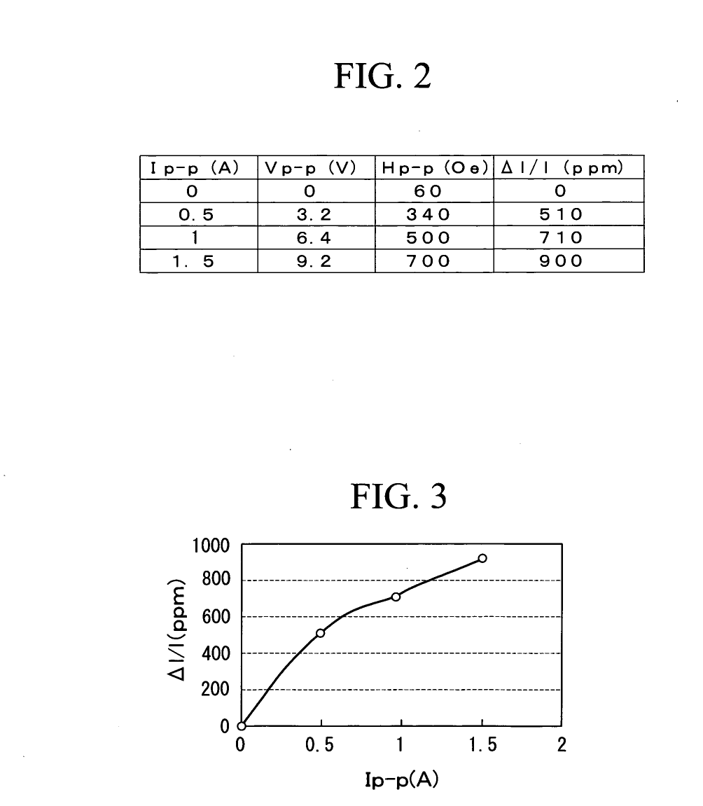

FIGS. 2 and 3 show driving properties of the vibrator 12 of a giant magnetostrictive material having an atomic composition of Tb_{0.3}Dy_{0.7}Fe_{2.0}, and a diameter of 2 mm and length of 13 mm. As shown, the vibrator 12 can generate an output, vibrating with amplitude in a range of ±3 μm, in response to driving current.

In FIG. 2, Ip-p is current (A) supplied to the drive coil 13, Vp-p is its voltage (V), Hp-p is intensity (Oe) of a magnetic field applied, and Δl/l is displacement (ppm) by the expanding/contracting movements (vibration) of the vibrator 12. The coil 13 has 600 winding turns and a length of 12 mm.

The vibrator 12 may be of a piezoelectric element. A piezoelectric element may be of a stacked or bimorph type, the latter being more suitable, because the stacked type, being composed of laminates, is fragile and unsuitable for sound frequency. It should be noted, however, that, when a piezoelectric element is used, a voltage-increasing circuit is additionally needed, by which is meant that it should be structured in such a way to prevent a high voltage from contacting with human bodies. Moreover, the bimorph type involves a disadvantage that it cannot generate a high output.

The magnets 14 and 15 are provided on both ends of the vibrator 12 and drive coil 13 around the vibrator 12. More specifically, the magnet 14 is positioned between the counter-mass 18 and vibrator 12, and the magnet 15 between the transmission rod 16 and vibrator 12. They are each a permanent magnet. Each magnet has the N-pole on one side and S-pole on the other side. They are positioned in such a way that the N-pole (or S-pole) of the magnet 14 faces the S-pole (or N-pole) of the magnet 15.

The magnets 14 and 15 are provided to apply a bias magnetic field to the magnetic field generated by the drive coil 13. This results in applying the bias magnetic field to the vibrator 12. It is therefore preferable that the magnets 14 and 15 are positioned on the vibrator 12 axis, and fixed on both ends of the vibrator 12 by an adequate means, e.g., adhesion.

The dimensions of these magnets 14, 15 may be adequately set in accordance with the vibrator 12 and drive coil 13 dimensions. For example, they may be 1 to 6 mm in diameter and 0.5 to 2 mm in thickness. However, these magnets preferably have a length in the radial direction larger than that of the vibrator 12 in the radial direction, in order to apply a bias magnetic field, as described above.

The transmission rod 16 is provided on the magnet 15 side of the vibrator 12 to transmit vibration generated by the vibrator 12 to the diaphragm 20. The transmission rod 16 is composed of the almost circular flange 16a in contact with the magnet 15 and rod body 16b extending from the flange 16a along the vibrator 12 axis. The rod body 16b projects toward the housing 11 outside by a given length (which is longer than the displacement of the working vibrator 12). The flange 16a may have a diameter of 4 to 14 mm and thickness of 0.5 to 2 mm, for example, and the rod body 16b may have a diameter of 2 to 4 mm and length of 10 to 20 mm, for example. As illustrated in FIG. 1, the diameters of the vibrator 12, magnet 15 and flange 16a preferably increase in the descending order, the flange 16a having the largest diameter.

The plug 19 having the through-hole 19a at the center is provided at the end of the housing 11, and the rod body 16b projects toward the housing 11 outside through the through-hole 19a. The diameter of the through-hole 19a is designed to be larger than the outer diameter of the rod body 16b by a given clearance, to allow the rod body 16b to transmit vibration generated by the vibrator 12 to the outside without contacting with the plug 19.

The preload member 17 of an elastic material, e.g., coil spring, is provided between the flange 16a of the transmission rod 16 and plug 19. The preload member 17 presses (energizes) the flange 16a and plug 19 to separate them from each other. As a result, it imparts a preload to the vibrator 12 via the flange 16a of the transmission rod 16, and the vibrator 12 is kept pressed to the counter-mass 18 provided on the other end.

The counter-mass 18 is provided on the vibrator 12 axis at its end opposite to the transmission rod 16, and fixed on the housing 11. The counter-mass 18 is provided at one side of vibrator 12, in the vibration direction, that is, at the other end of the rod-shape vibrator 12, on the centerline of the vibrator 12 axis.

The counter-mass 18 is provided to selectively transmit the displacement, generated when the vibrator 12 is driven to expand/contract, to the transmission rod 16. It preferably has a sufficient mass, e.g., at least 100 to 200 times larger than that of the vibrator 12, essentially not to vibrate when the vibrator 12 is driven to expand/contract. In other words, it preferably has a sufficient mass to exhibit an inertia force several hundreds times larger than the force generated by the vibrator 12 when it is driven to expand/contract. Moreover, it is preferably provided on the centerline of the vibrator 12 in a concentrated manner while spreading in the radial direction is prevented as far as possible so that the inertia force is effectively exerted on (the vibration of) the vibrator 12.

The counter-mass 18 may be made of a metal, ceramic or the like. A soft magnetic, e.g., MnZn-based ferrite is a particularly suitable material for the counter-mass 18. It is a magnetic material of limited loss at a high frequency, and can help operate the magnetic field generated by the drive coil 13 and magnets 14 and 15 under favorable conditions.

The counter-mass 18 can be firmly fixed on, and integrated with, the housing 11. This adds the masses of the housing 11 and drive coil 13 to the counter-mass 18.

The speaker core 10 described above can be connected to a sound signal output device via a connector (not shown) in such a way that a lead 21 for energizing the drive coil 13, which is made to run through the housing 11 or counter-mass 18 so as to being taken out of the speaker core 10. The sound signal out put device may be an amplifier, recording medium reproduction device for CDs, DVDs, cassette tapes or the like, television receiver, microphone, or the like which outputs a sound signal (electrical signal) in response to sound.

The speaker core 10 can be so structured as to receive a sound signal wirelessly from the above-described sound signal output device.

In this case, the sound signal output device (not shown) is provided with a transmitter, which transmits a sound signal, and the speaker core 10 is provided with a receiver, which receives the sound signal from the sound signal output device.

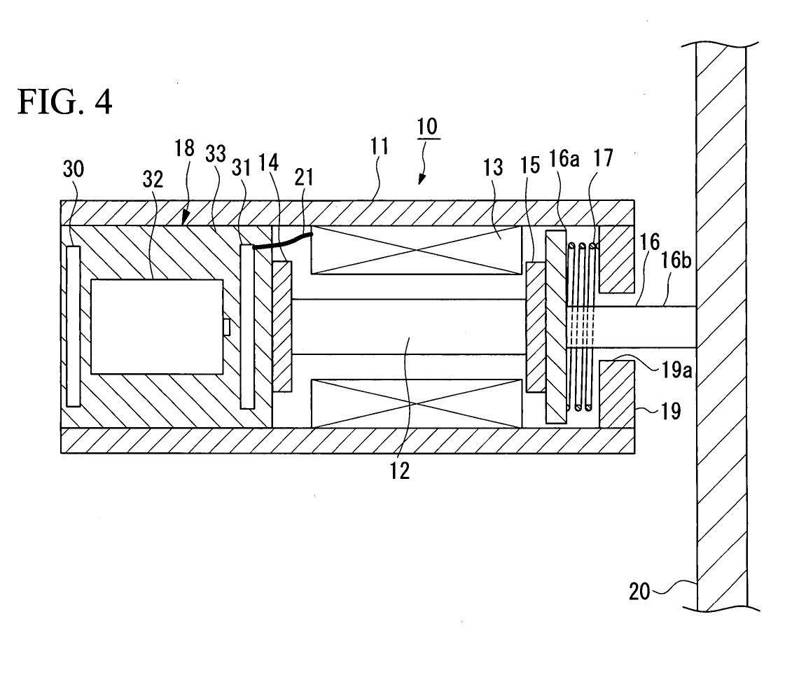

More specifically, as illustrated in FIG. 4, the speaker core 10 is additionally provided with the antenna 30 as a receiver, the receiver circuit 31 which converts the sound signal received by the antenna 30 into current of waveform (voltage) in response to the sound signal and outputs it to the drive coil 13, and a battery 32 which drives the receiver circuit 31 or supplies electric power produced by the receiver circuit 31.

Moreover, it is preferable that the case 33, which at least holds the receiver circuit 31 and battery 32, is mounted as the counter-mass 18 in the housing 11.

In other words, the masses of the receiver circuit 31, the battery 32 and case 33 are used as the counter-mass 18. In particular, a battery of varying type, e.g., dry battery, used as the battery 32 is suitable for the counter-mass 18, because of its relatively large mass per unit volume. Moreover, the case 33 is preferably made of a material, which increases mass per unit volume of the portion other than those for the battery 32 and receiver circuit 31. The contact terminal for the battery 32, which itself is elastic like a spring, preferably has a high rigidity for using the battery 32 as the counter-mass 18.

The speaker core 10 can output sound by bringing the transmission rod 16 in contact with the diaphragm 20, as illustrated in FIGS. 1 and 4. It can output sound efficiently, because vibration generated by the expanding/contracting movements of the vibrator 12 can be efficiently transmitted to the transmission rod 16 on account of the counter-mass 18 which it holds. Moreover, vibration of the vibrator 12 is concentrated at one end on account of the counter-mass 18 to eliminate necessity for strongly pressing the speaker core 10 to the diaphragm 20, even when, for example, it is to be pressed by hand to the diaphragm 20. This effect is more noted when the speaker core 10 is pressed downwards to the diaphragm 20, because gravity of the counter-mass 18 itself is added.

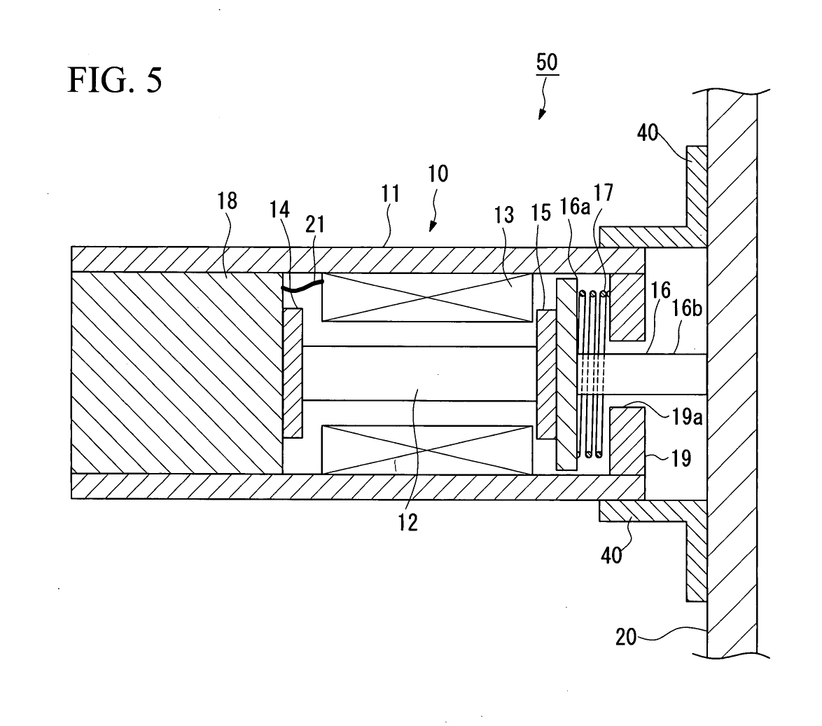

Moreover, as illustrated in FIG. 5, the speaker core 10 can be fixed on the diaphragm 20 by the bracket (joint) 40 or the like to produce the speaker unit 50 with the integrated diaphragm 20. Vibration can be efficiently transmitted on account of the counter-mass 18 from the vibrator 12 to the diaphragm 20 via the transmission rod 16 also in this case. Therefore, it is not necessary for the bracket 40 to be particularly robust. A box-type enclosure can be eliminated, needless to say, unlike the case with a conventional speaker.

As described above, the counter-mass 18 is provided on one end of the vibrator 12, and vibration generated by the vibrator 12 driven by the drive coil 13 to expand/contract can be efficiently transmitted to the diaphragm 20 on the other end in the speaker core 10 and speaker unit 50 provided therewith. Therefore, the bracket 40 for fixing the speaker core 10 on the diaphragm 20 is not required to be particularly robust, to help decrease size and mass of the speaker core 10 and speaker unit 50 provided therewith. In particular, the counter-mass 18 can exhibit an inertia force efficiently for the vibrator 12, because it is provided on the vibrator 12 axis, to bring the above effect more assuredly.

Moreover, the speaker core 10 can transmit vibration of the vibrator 12 to the diaphragm 20 much more efficiently than a one provided with no counter-mass, e.g., the counter-mass 18 used for the present invention, even when it is to be pressed to the diaphragm 20 by hand. As a result, the diaphragm 20 can vibrate to well output sound even when the speaker core 10 is not strongly pressed thereto. In this way of use, the diaphragm 20 material is not limited to cone paper ordinarily used for speakers, but various others, e.g., desk, wall and white board, may be used. In other words, the speaker core 10 can be used as a handy speaker which can output sound by simply bring it into contact with, or placing it on, an object, which works as the diaphragm 20.

The speaker core 10 can be formed to have an unprecedented stick shape by using the rod-shape vibrator 12 and keeping length in the vibrator vibration direction larger than that in the direction perpendicular to the vibration direction. This allows the drive coil 13 to be used as the counter-mass by extending it in the housing 11 along its axis.

The speaker core 10 is also provided with the magnets 14 and 15 on both ends of the vibrator 12. They are provided on the vibrator 12 axis, which is a preferable configuration for concentration of mass. In particular, the magnet 14 on the counter-mass 18 can also work as a counter-mass. As described above, the magnets 14 and 15 work to apply a bias magnetic field to the vibrator 12. However, one of these magnets may be eliminated and a bias magnetic field may be applied only by the remainder. It is however more preferable that a pair of permanent magnets, i.e., the magnets 14 and 15, are provided in such a way to have the vibrator 12 in-between, in order to efficiently apply a bias magnetic field to the vibrator 12.

The speaker core 10 and speaker unit 50 structures are specifically described in the above embodiments. However, it is to be understood that features and materials may be modified, omitted, or added for the components without departing from the sprit and scope of the present invention.

For example, the speaker unit 50 can be covered over the vibrator 20 back side and speaker core 10. It can be made very thin even in the above case.

Other variations can be made without departing from the sprit and scope of the present invention.

### INDUSTRIAL APPLICABILITY

The present invention, which is provided with a counter-mass on one end of a vibrator, can efficiently transmit vibration generated by expanding/contracting movements of the vibrator to a diaphragm, and can help decrease size and mass of the sound output device and speaker unit.

Moreover, the sound output device of the present invention can be also used as a portable speaker, because it can output sound only by being brought into contact with, or placed on, an object, which works as a diaphragm.

1. A speaker unit comprising:
a vibrator which has one end and the other end and vibrates in a given direction in response to an incoming signal,
a counter-mass which is provided on said one end of said vibrator, and
a diaphragm which is connected to said vibrator at said other end and outputs sound when it receives vibration from said vibrator, wherein
said counter-mass transmits the vibration from said vibrator in a concentrated manner to said diaphragm side.

2. The speaker unit according to claim 1 which is additionally provided with:
a receiver circuit which receives an external signal transmitted wirelessly and
a battery which supplies electric power to said receiver circuit, wherein
at least one of said receiver circuit and said battery is used as said counter-mass.

3. The speaker unit according to claim 1, wherein:
said vibrator is a magnetostrictive element comprising a giant magnetostrictive material containing Tb, Dy and Fe.

4. The speaker unit according to claim 1, wherein:
a permanent magnet which applies a bias magnetic field to said vibrator is provided on an axis of said vibrator.

5. The speaker unit according to claim 4, wherein:
said permanent magnet is provided on said one end and said other end of said vibrator respectively.

6. The speaker unit according to claim 1, wherein:
said counter-mass is composed of a soft magnetic material.

7. A sound output device comprising:
a vibrator which has one end and the other end and vibrates in a given direction in response to an incoming signal,
a counter-mass which is positioned on said one end of said vibrator and has a given multiple or more of mass than that of said vibrator,
a housing which holds said vibrator and said counter-mass and
a transmission member which transmits vibration generated by said vibrator at said other end to said housing outside.

8. The sound output device according to claim 7, which is provided with:
a first permanent magnet which is positioned between said counter-mass and said vibrator, and
a second permanent magnet which is positioned between said transmission member and said vibrator.

9. The sound output device according to claim 7, wherein:
said sound output device is stick-shaped as a whole by structuring said housing such that the length thereof in the vibrator direction of the vibrator is larger than that in the direction perpendicular to the vibration direction.

10. The sound output device according to claim 7, wherein:
said vibrator is a magnetostrictive element comprising a giant magnetostrictive material containing Tb, Dy and Fe, and
a drive coil is provided around said vibrator in said housing for generating a magnetic field in response to an incoming signal and making said vibrator vibrate with the magnetic field.

11. The sound output device according to claim 7, wherein:
said counter-mass provides an inertia force only in the vibration direction of said vibrator when said vibrator vibrates.

12. The sound output device according to claim 7, wherein:
said counter-mass has a mass 10 to 200 times larger than that of said vibrator.

13. The sound output device according to claim 7, wherein:
a diaphragm which outputs sound when it receives vibration from said vibrator via said transmission member is provided.

14. The sound output device according to claim 13, wherein:
a joint which attaches said housing and said diaphragm to each other is provided.

15. The sound output device according to claim 7, which is further provided with:
a receiver circuit which receives an external signal transmitted wirelessly,
a battery which supplies electric power to said receiver circuit, and
a casing which holds said receiver circuit and said battery, wherein
said casing, and said receiver circuit and said battery held in said casing work as said counter-mass.

16. A sound output device comprising:
a cylindrical housing,
a receiver which is held in the housing and receives an external signal transmitted wirelessly,
a vibrator which is held in said housing and vibrates in the axial direction of said housing in response to the signal received by said receiver, and
a transmission member which transmits vibration from said vibrator to the outside.

17. The sound output device according to claim 16, which is further provided with:
a receiver circuit which receives an external signal transmitted wirelessly,
a battery which supplies electric power to said receiver circuit and
a casing containing said receiver circuit and said battery and held by said housing,
wherein said casing containing said receiver circuit and said battery has a given multiple or more of mass than that of said vibrator.

18. The sound output device according to claim 16, wherein:
said vibrator is a magnetostrictive element comprising a sintered body having an atomic composition of Tb_{X}Dy_{1-X}Fe_{Y} (wherein, X is 0.25 to 0.50 and Y is 1.7 to 2.0), and
a drive coil is provided around said vibrator in said housing for generating a magnetic field in response to an incoming signal and making said vibrator vibrate with the magnetic field.

19. The sound output device according to claim 16, wherein:
said sound output device is stick-shaped as a whole by structuring said housing such that the length thereof in the vibrator direction of the vibrator is larger than that in the direction perpendicular to the vibration direction.

20. The sound output device according to claim 7 or 16, wherein:
said sound output device is portable.
